(19) United States
(12) Patent Application Publication
(10) Pub. No.: US 2025/0075350 A1
(43) Pub. Date: Mar. 6, 2025

(54) PROTECTIVE BARRIER FOR ELECTROCHEMICAL DEVICE

(71) Applicant: HYAXIOM, INC., East Hartford, CT (US)

(72) Inventor: Jesse Marzullo, New Paltz, NY (US)

(21) Appl. No.: 18/460,914

(22) Filed: Sep. 5, 2023

(51) Int. Cl. C25B 11/069; C25B 11/036; C25B 13/05

(52) U.S. Cl. CPC C25B 11/069; C25B 11/036; C25B 13/05

(57) ABSTRACT

An assembly for an electrochemical device may include, among other things, a conductive metallic plate and at least one carbon layer extending along the metallic plate. The at least one carbon layer may include a plurality of carbon fibers that may establish a porous construct. A plastic film may extend between the metallic plate and the at least one carbon layer. The plastic film may impregnate the porous construct such that the at least one carbon layer may be substantially impermeable to fluid. At least some of the carbon fibers may extend through the plastic film to establish a conductive path between the at least one carbon layer and the metallic plate. A method of forming an electrochemical device is also disclosed.

### BACKGROUND

This disclosure relates to electrochemical devices that may incorporate metallic components and methods of operation.

Electrolyzers are known electrochemical devices that may be configured to convert electricity and water into hydrogen and oxygen. Metallic parts exposed to the environment of the electrolyzer may corrode at the highly acidic conditions, may form stable oxides that may reduce conductivity, or may hydrogen embrittle. Some arrangements may include a coating on the metallic parts with a precious metal such as gold, a stable “valve” metal such as titanium (Ti) or nobium (Nb), and/or their nitrides/carbides. The coating may need to be defect-free to protect the metallic part. Other arrangements may utilize a solid carbon flow field plate to establish a cathode flow field half of a bipolar plate assembly.

### SUMMARY

An assembly for an electrochemical device may include a conductive metallic plate. At least one carbon layer may extend along the metallic plate. The at least one carbon layer may include a plurality of carbon fibers that may establish a porous construct. A plastic film may extend between the metallic plate and the at least one carbon layer. The plastic film may impregnate the porous construct such that the at least one carbon layer may be substantially impermeable to fluid. At least some of the carbon fibers may extend through the plastic film to establish a conductive path between the at least one carbon layer and the metallic plate.

An electrochemical device may include a proton exchange membrane between an anode and a cathode. A conductive metallic plate may be adjacent to a fluid stream of the cathode. A protective barrier may be disposed along the plate. The protective barrier may include one or more carbon layers that each may have a porous construct that may be established by a plurality of carbon fibers. A plastic film may extend between the metallic plate and the one or more carbon layers. The plastic film may impregnate the porous construct such that the one or more carbon layers may be substantially impermeable to fluid through the fluid stream. At least some of the carbon fibers may extend through the plastic film to establish a conductive path between the one or more carbon layers and the metallic plate.

A method of forming an electrochemical device may include disposing a plastic film between a metallic separator plate and a carbon layer. The carbon layer may have a porous construct that may be established by a plurality of carbon fibers. The method may include establishing a protective barrier in response to compressing the carbon layer to cause the plastic film to impregnate the porous construct such that the carbon layer may be substantially impermeable to hydrogen fluid.

The present disclosure may include any one or more of the individual features disclosed above and/or below alone or in any combination thereof.

Various features and advantages of at least one disclosed example embodiment will become apparent to those skilled in the art from the following detailed description. The drawing that accompanies the detailed description can be briefly described as follows.

### BRIEF DESCRIPTION OF THE DRAWING

FIG. 1 schematically discloses a system including electrochemical devices arranged in a stack.

FIG. 2 discloses a sectional view of an assembly for an electrochemical device.

FIG. 3 disclose a portion of the assembly of FIG. 2.

FIG. 4 discloses a sectional view of another assembly for an electrochemical device.

FIG. 5 disclose a portion of the assembly of FIG. 4.

FIG. 6 discloses a method of forming an assembly that may be incorporated in an electrochemical device.

Like reference numbers and designations in the various drawings indicate like elements.

### DETAILED DESCRIPTION

Assemblies for electrochemical devices such as a proton exchange membrane (PEM) electrolyzer or fuel cell may include one or more conductive metallic plates or other components. A protective barrier may be established along the metallic components.

In implementations, one or more relatively thin, porous conductive carbon paper sheets may be impregnated substantially or fully across a face of the respective sheet and partially through a thickness of the sheet with a substantially fluid (e.g., gas) impermeable material for establishing a protective barrier. The impermeable material may be conductive or non-conductive. The non-conductive material may be a thermoplastic or other non-conductive material. The thermoplastic may be suitable for use in a high-pressure hydrogen environment. In other implementations, the impermeable material may be a conductive material such as a graphite paste. In implementations, impregnation can be performed by laminating two or more carbon paper sheets together and placing them against a metallic plate, or by laminating one or more carbon paper sheets directly onto the metallic plate or other component. The sheets and thermoplastic may be hot-pressed such that the electrically conductive carbon fibers may push through the hot plastic film and establish sufficient contact with the surface of the metallic component to which they may be bonded to. The carbon sheet(s) and plastic film may be secured to the metallic plate once the plastic is cooled. The plastic may substantially fill the pore structure of the carbon paper in-plane, resulting in a substantially gas-impermeable barrier. An appropriate starting thickness of the plastic film may be selected based on a thickness of the carbon paper sheet and porosity such that a conductive path may be established across the barrier subsequent to fabrication. The resultant protective barrier may be gas impermeable thru-plane and may be electrically conductive both thru-plane and in-plane, and may still be relatively thin (e.g., 0.003-0.006 inches). The protective barrier may be suitable to withstand relatively high cross-pressures, but it may be as conductive as the bare carbon paper.

An assembly for an electrochemical device may include a conductive metallic plate. At least one carbon layer may extend along the metallic plate. The at least one carbon layer may include a plurality of carbon fibers that may establish a porous construct. A protective film may extend between the metallic plate and the at least one carbon layer. The protective film may impregnate the porous construct such that the at least one carbon layer may be substantially impermeable to fluid. At least some of the carbon fibers may extend through the protective film to establish a conductive path between the at least one carbon layer and the metallic plate.

In any implementations, the carbon fibers may be randomly distributed in the at least one carbon layer.

In any implementations, the metallic plate may comprise titanium.

In any implementations, the protective film may be a solid protective layer.

In any implementations, the protective layer may comprise a thermoplastic.

In any implementations, the protective film may be a spray-on material.

In any implementations, the at least one carbon layer may include one or more carbon paper sheets.

In any implementations, the at least one carbon layer may be bonded directly to the metallic plate.

In any implementations, the at least one carbon layer may include a first carbon layer and a second carbon layer. The protective film may be sandwiched between the first and second carbon layers such that the fibers of the first carbon layer and the fibers of the second carbon layer may contact each other in the protective film to establish a portion of the conductive path.

In any implementations, the metallic plate may be a separator plate and/or a bipolar plate for a proton exchange membrane (PEM) electrolyzer.

An electrochemical device may include a proton exchange membrane between an anode and a cathode. A conductive metallic plate may be adjacent to a fluid stream of the cathode. A protective barrier may be disposed along the plate. The protective barrier may include one or more carbon layers that each may have a porous construct that may be established by a plurality of carbon fibers. A protective film may extend between the metallic plate and the one or more carbon layers. The protective film may impregnate the porous construct such that the one or more carbon layers may be substantially impermeable to fluid through the fluid stream. At least some of the carbon fibers may extend through the protective film to establish a conductive path between the one or more carbon layers and the metallic plate.

In any implementations, the carbon layer may establish a boundary of the fluid stream.

In any implementations, the one or more carbon layers may include a first carbon layer and a second carbon layer. The protective film may be sandwiched between the first and second carbon layers.

In any implementations, the protective film may include a non-conductive material. The carbon fibers of the first carbon layer and the carbon fibers of the second carbon layer may contact each other in the protective film to establish the conductive path.

In any implementations, the metallic plate may be a separator plate and/or a bipolar plate.

A method of forming an electrochemical device may include disposing a protective film between a metallic separator plate and a carbon layer. The carbon layer may have a porous construct that may be established by a plurality of carbon fibers. The method may include establishing a protective barrier in response to compressing the carbon layer to cause the protective film to impregnate the porous construct such that the carbon layer may be substantially impermeable to hydrogen fluid.

In any implementations, the protective film comprises a non-conductive material. The compressing step may occur such that at least some of the carbon fibers may extend through the protective film to establish a conductive path between the carbon layer and the metallic plate.

In any implementations, the compressing step may include applying a compressive force that may be between approximately 420 pounds per square inch (PSI) and approximately 500 PSI.

In any implementations, the disposing step may include spraying a plastic material on the separator plate and/or the carbon layer to establish the protective layer.

In any implementations, the method may include arranging the protective barrier adjacent to a fluid stream of a cathode.

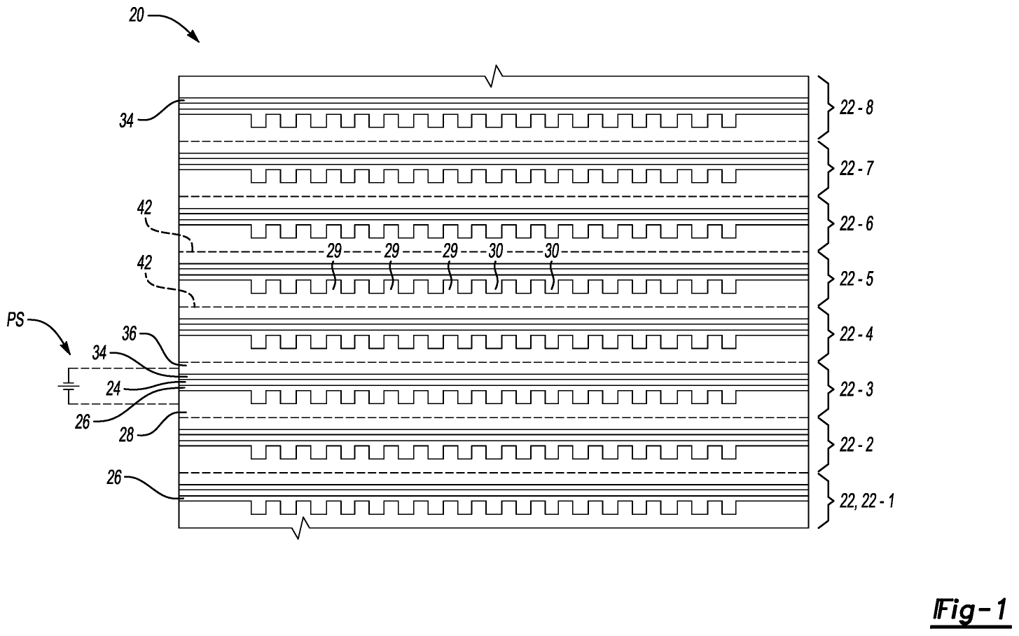

FIG. 1 schematically illustrates an electrochemical system 20. In implementations, the electrochemical system 20 may be an electrolyzer, such as a proton exchange membrane (PEM) electrolyzer. Other systems and systems may benefit from the teachings disclosed herein, such as a hydrogen fuel cell.

A plurality of cells 22 may be arranged in a stack. In the implementation of FIG. 1, the system 20 may include at least eight cells (indicated at 22-1 to 22-8). Although a total of eight cells are disclosed, it should be understood that fewer or more than eight cells may be utilized, such as only one cell. The illustrated stack may be considered a sub-stack that may be incorporated in multiple sub-stacks of a larger stack.

Each of the cells 22 may include a matrix 24 containing an electrolyte, such as a solid polymer electrolyte (SPE). The matrix 24 may serve as a membrane.

A cathode 26 may be situated on one side of the matrix 24. A cathode flow field 28 adjacent to the cathode 26 may include a plurality of ribs 29 and channels 30 that may establish flow passages for collecting hydrogen (H₂) generated by the electrochemical reaction and carrying the hydrogen away from the cell 22. In implementations, water (H₂O) may be utilized to sweep hydrogen away from the cell 22. The flow passages of the cathode flow field 28 may be arranged into or out of the page in the illustration. The cathode 26 may include a catalyst adjacent to the matrix 24 and a gas diffusion layer (GDL) adjacent to the cathode flow field 28.

An anode 34 may be situated on an opposite side of the matrix 24 from the cathode 26. The matrix 24 may be situated between the anode 34 and cathode 26. An anode flow field 36 may include flow channels (not illustrated) that may supply reactant, such as water, to the anode 34. The flow passages may carry oxygen (O₂) generated from the electrochemical reaction and/or remaining water away from the cell 22. In FIG. 1, the flow channels of the anode flow field 36 may be parallel to the page and may be oriented from one side of the illustrated cell 22 to the other side. Although not specifically shown, the anode flow field 36 may include a plurality of ribs and channels. The ribs and channels of the anode flow field 36 may be perpendicularly oriented relative to the ribs 29 and channels 30 of the cathode flow field 28. The anode 34 may include a catalyst adjacent to the matrix 24 and a gas diffusion layer (GDL) adjacent to the anode flow field 36.

The individual cells 22 may be separated by a separator 38 as schematically shown by the broken lines. In implementations, the cathode flow field 28 and anode flow field 36 of adjacent cells 22 may be established by a single, bipolar plate that may also serve as the separator 38 between the adjacent cells 22. The bipolar plates may be coupled to a (e.g., direct current) power source PS for inducing a current across the cell 22.

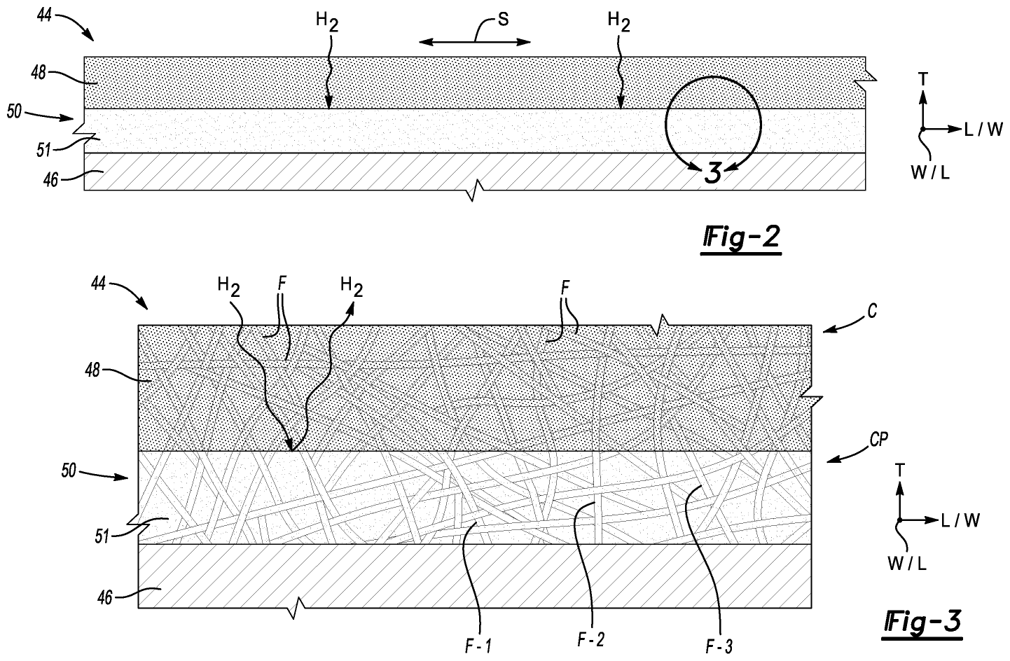

Referring to FIGS. 2-3, an assembly 44 for an electrochemical device is disclosed. The electrochemical device may be any of the electrochemical devices disclosed herein, such as an electrolyzer or fuel cell. The assembly 44 may include a conductive metallic component (e.g., plate) 46. In implementations, the metallic plate 46 may be a bipolar plate and/or separator for an electrochemical device, such as a PEM electrolyzer. The assembly 44 may be incorporated into other systems in accordance with the teachings disclosed herein, including any application where a conductive metallic surface may benefit by being robustly protected from an environment where carbon and plastic may be suitable, such as PEM fuel cell current collectors. The metallic plate 46 may be arranged adjacent to a fluid stream S, such as a fluid stream of a cathode (e.g., cathode 26 of FIG. 1). The metallic plate 46 may comprise various metallic materials, such as titanium or stainless steel. The plate 46 may have various geometries, such as a generally planar geometry.

At least one conductive fiber layer 48 may extend along the metallic plate 46. In implementations, the fiber layer(s) 48 may substantially follow a contour of the plate 46. Each fiber layer 48 may include one or more fibers F that may establish a porous construct C (FIG. 3). The fibers F may comprise a conductive material. In implementations, the fiber layer 48 may be a carbon layer including carbon fibers F that establish the porous construct C. The carbon layer 48 may include one or more carbon paper sheets stacked on each other. Each of the sheets may include a network of the fibers F. In implementations, the fiber layer 48 may be bonded directly to the metallic plate 46. The fiber layer 48 may establish or otherwise extend along a boundary of the fluid stream S.

A protective barrier (e.g., layer or covering) 50 may be disposed along, or otherwise adjacent to, the metallic plate 46. The protective barrier 50 may be an electrically conductive, gas impermeable protective barrier. The protective barrier 50 may establish a barrier to hydrogen gas and/or other fluid along the fluid stream S. In implementations, the protective barrier 50 may establish a coating that substantially or completely blocks permeation of fluid such as hydrogen gas through the conductive layer(s) 48 to the metal plate 46. For the purposes of this disclosure, the terms “approximately” and “substantially” mean ±5% of the stated value or relationship unless otherwise indicated. Protecting the metallic plate 46 from the fluid stream S may reduce a likelihood of corrosion and embrittlement. The protective barrier 50 may be gas impermeable in a thickness direction T (e.g., through plane) and may be electrically conductive in a thickness direction T and lengthwise/widthwise directions L/W (e.g., in-plane).

Various techniques may be utilized to establish the protective barrier 50. The protective barrier 50 may be established by a non-metallic material such as plastic or may be a conductive material such as graphite. The graphite may be in the form of a graphite paste. In implementations, the protective barrier 50 may be established by a relatively thin plastic film 51. The plastic film 51 may extend between the metallic plate 46 and the fiber layer(s) 48. The plastic film 51 may include a thermoplastic or other plastic material. Plastic materials may include high density polyethylenes (HDPE) and polytetrefluoroethylenes (PTFE). The plastic film 51 may be a solid plastic layer. In implementations, the plastic film 51 may be established by a spray-on material. The plastic material may be curable and may serve as an adhesive. The plastic material may be suitable adhering directly to surface of the metallic plate 46.

Referring to FIG. 3, with continuing reference to FIG. 2, the fibers F may be randomly distributed in the fiber layer 48 to establish the porous construct C. The plastic film 51 may impregnate the porous construct C such that the fiber layer 48 may be substantially impermeable to fluid, such as hydrogen gas through the fluid stream S. At least some of the fibers F may have a length that may be equal to or greater than a thickness of the plastic film 51 such that the respective fibers F may protrude outwardly from an opposite side of the plastic film 51. The fibers F may cooperate to establish a conductive path CP between the fiber layer(s) 48 and the metallic plate 46. At least some of the fibers F may extend through the plastic film 51 to establish the conductive path CP (see, e.g., fibers F-1 to F3).

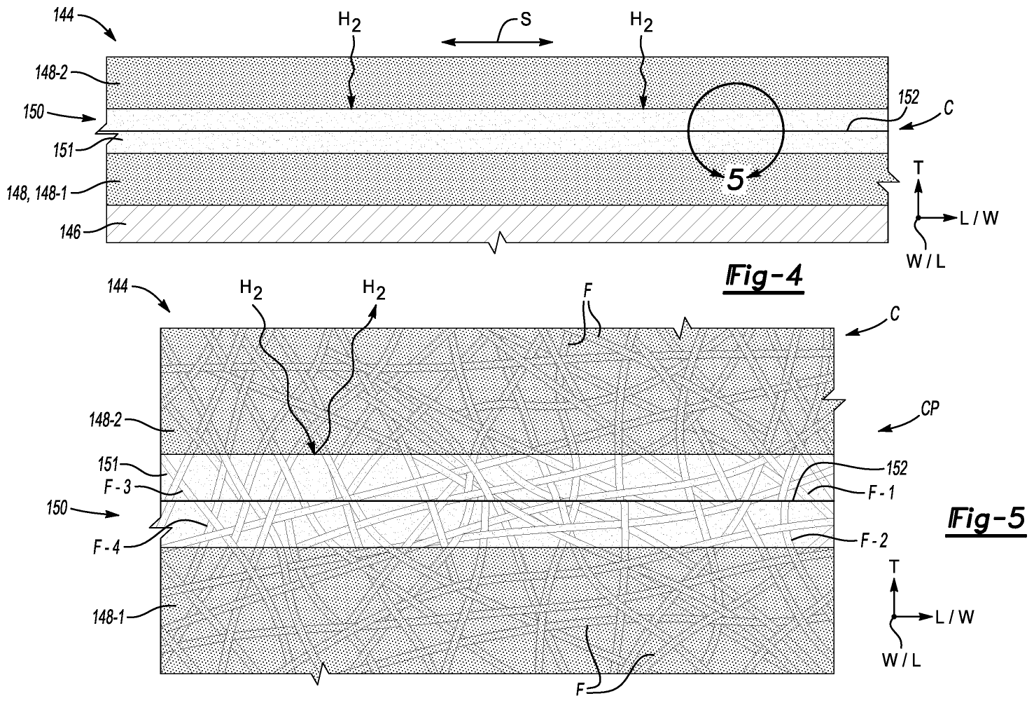

Referring to FIG. 4, an assembly 144 for an electrochemical device is disclosed. In this disclosure, like reference numerals designate like elements where appropriate and reference numerals with the addition of one-hundred or multiples thereof designate modified elements that are understood to incorporate the same features and benefits of the corresponding original elements. The assembly 144 may include one or more conductive fiber layers 148. Each fiber layer 148 may include one or more fibers F that may establish a porous construct C. Each of the fiber layers 148 may be a carbon fiber layer established by one or more carbon fibers F. In the implementation of FIG. 4, the assembly 144 may include a first (e.g., inner) fiber layer 148-1 and a second (e.g., outer) fiber layer 148-2. Although two fiber layers 148 are disclosed, it should be understood that fewer or more than two fiber layers 148 may be utilized in accordance with the teachings disclosed herein. Each fiber layer 148 may include one or more carbon paper sheets.

A protective barrier 150 may be established between the adjacent portions of the first and second fiber layers 148-1, 148-2. The protective barrier 150 may be established by a substantially impermeable protective film 151. The protective film 151 may be a solid plastic layer that may be arranged between the fiber layers 148-1, 148-2.

Referring to FIG. 5, with continuing reference to FIG. 4, the protective film 151 of the protective barrier 150 may be sandwiched between the first and second fiber layers 148-1, 148-2 such that one or more fibers F of the first carbon layer 148-1 and one or more fibers F of the second carbon layer 148-2 may contact each other along an interface 152 in the protective barrier 150 to establish a portion of the conductive path C. The conductive path C may be established between the second fiber layer 148-2 and the metallic plate 146.

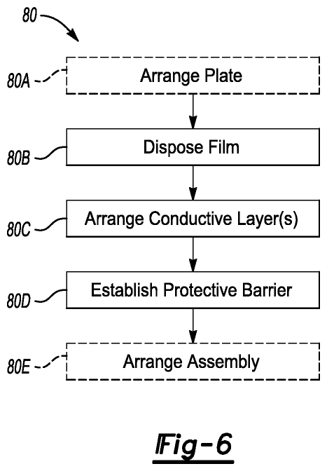

Referring to FIG. 6, a method of forming an assembly for an electrochemical device in a flowchart 80 is disclosed. Method 80 may be utilized to form various electrochemical devices, including any of the electrochemical devices disclosed herein and/or components thereof. Fewer or additional steps than are recited below could be performed within the scope of this disclosure, and the recited order of steps is not intended to limit this disclosure. Reference is made to the assemblies 44, 144 of FIGS. 2-5.

At step 80A, a conductive component (e.g., plate) 46 may be arranged. The plate 46 may be positioned on a fixture or other component suitable for fabricating the device. In implementations, the plate 46 may be a metallic bipolar and/or separator plate. The plate 46 may incorporate any of the materials disclosed herein, such as titanium.

At step 80B, a substantially impermeable protective layer (e.g., film) 51 may be disposed on or otherwise adjacent to the plate 46. The film 51 may include any of the materials disclosed herein, including non-conductive materials such as plastic and conductive materials such as graphite (e.g., paste). Step 80B may include arranging a solid plastic layer or a graphite paste along the plate 46 and/or conductive layer(s) 48. In other implementations, step 80B may include spraying a plastic material on the plate 46 and/or conductive layer(s) 48 to establish the film 51.

At step 80C, one or more conductive layers 48 may be arranged relative to the plate 46 and/or protective film 51. Each conductive layer 48 may include any of the arrangements disclosed herein, such as a carbon layer including one or more fibers F that may establish a porous construct C. In implementations, step 80C may include arranging conductive layers 148-1, 148-2 in abutment to establish an interface 152. In implementations, steps 80B and 80C may occur such that the film 51 may be disposed between the conductive plate 46 and the conductive layer(s) 48.

At step 80D, a protective barrier 50 may be established. Various techniques may be utilized to establish the protective barrier 50, including any of the techniques disclosed herein. The protective barrier 50 may serve to protect the conductive plate 46 from fluid in the fluid stream S, such as hydrogen gas and/or other fluid. In implementations, the protective barrier 50 may be established in response to compressing the conductive layer(s) 48 against the conductive plate 46 to cause the protective film 51 to impregnate the porous construct C such that the conductive layer(s) 48 is substantially impermeable to the fluid. The plastic material may substantially or completely fill the pores of the porous construct C and may secure all of the layers 48, 50 together. The protective barrier 150 may be substantially impermeable to fluid along the interface 152 between the conductive layers 148-1, 148-2. Step 80D may occur such that the conductive layer(s) 48 and protective film 51 may establish a laminate in response to applying the compression and curing the plastic material. Step 80D may occur such that the conductive layer(s) 48 may be secured to surfaces of the conductive plate 46.

Compressing the conductive layer(s) 48 may occur such that at least some of the fibers F may extend through the protective film 51 and contact the plate 46 to establish an electrically conductive path C between the conductive layer(s) 48 and the conductive plate 46. One or more fibers F may be exposed on an opposite side of the conductive layer 48 such that electrically conductive contact can be established between the conductive plate 46 and another component situated against the conductive layer 48 (see, e.g., conductive layers 148-1, 148-2). Step 80D may include applying a compressive force. The compressive force may an amount adequate to establish conductivity that may substantially match unbonded carbon paper. In implementations, the compressive force may be between approximately 420 pounds per square inch (PSI) and approximately 500 PSI that may be applied for a suitable duration.

Each conductive layer 48 may include one or more carbon paper sheets. The carbon paper sheet may have a thickness between approximately 4/1000 inches and approximately 15/1000 inches. The protective film 51 may have a total thickness of less than a thickness of the adjacent conductive layer(s) 48 such that at least some of the fibers F may extend through both sides of the protective film 51.

At step 80E, the assembly 44 incorporating the protective barrier 50 may be arranged to establish a portion of an electrochemical device, such as the electrochemical system 20 of FIG. 1. In implementations, step 80E may include arranging the protective barrier 50 adjacent to a fluid stream S, such as a fluid stream of a cathode.

The disclosed techniques may be utilized to establish a protective barrier that may serve to protect conductive metallic components adjacent to relatively corrosive fluid stream, substantially maintain conductivity and may reduce a likelihood of embrittlement. The protective barrier may be substantially gas-impermeable and may be electrically conductive. The disclosed techniques may be relatively less expensive to fabricate than precious metal coatings. Plastic film and carbon paper may be relatively inexpensive. The disclosed arrangements may have improved reliability over other thin film coatings and may be much thinner and less inexpensive than a carbon flow field plate.

The preceding description is illustrative rather than limiting in nature. Variations and modifications to the disclosed examples may become apparent to those skilled in the art that do not necessarily depart from the essence of this invention.

What is claimed:

1. An assembly for an electrochemical device comprising:
a conductive metallic plate;
at least one carbon layer extending along the metallic plate, the at least one carbon layer including a plurality of carbon fibers that establish a porous construct; and
a protective film extending between the metallic plate and the at least one carbon layer, wherein the protective film impregnates the porous construct such that the at least one carbon layer is substantially impermeable to fluid, and at least some of the carbon fibers extend through the protective film to establish a conductive path between the at least one carbon layer and the metallic plate.

2. The assembly as recited in claim 1, wherein the carbon fibers are randomly distributed in the at least one carbon layer.

3. The assembly as recited in claim 1, wherein the metallic plate comprises titanium.

4. The assembly as recited in claim 1, wherein the protective film is a solid plastic layer.

5. The assembly as recited in claim 4, wherein the plastic layer comprises a thermoplastic.

6. The assembly as recited in claim 1, wherein the protective film is a spray-on material.

7. The assembly as recited in claim 1, wherein the at least one carbon layer includes one or more carbon paper sheets.

8. The assembly as recited in claim 1, wherein the at least one carbon layer is bonded directly to the metallic plate.

9. The assembly as recited in claim 1, wherein the at least one carbon layer includes a first carbon layer and a second carbon layer, and the protective film is sandwiched between the first and second carbon layers such that the fibers of the first carbon layer and the fibers of the second carbon layer contact each other in the protective film to establish a portion of the conductive path.

10. The assembly as recited in claim 1, wherein the metallic plate is a separator plate and/or a bipolar plate for a proton exchange membrane (PEM) electrolyzer.

11. An electrochemical device comprising:
a proton exchange membrane between an anode and a cathode;
a conductive metallic plate adjacent to a fluid stream of the cathode; and
a protective barrier disposed along the plate, the protective barrier comprising:
one or more carbon layers each having a porous construct established by a plurality of carbon fibers; and
a protective film extending between the metallic plate and the one or more carbon layers, wherein the protective film impregnates the porous construct such that the one or more carbon layers are substantially impermeable to fluid through the fluid stream, and at least some of the carbon fibers extend through the protective film to establish a conductive path between the one or more carbon layers and the metallic plate.

12. The electrochemical device as recited in claim 11, wherein the carbon layer establishes a boundary of the fluid stream.

13. The electrochemical device as recited in claim 11, wherein the one or more carbon layers include a first carbon layer and a second carbon layer, and the protective film is sandwiched between the first and second carbon layers.

14. The electrochemical device as recited in claim 13, wherein the protective film comprises a non-conductive material, and the carbon fibers of the first carbon layer and the carbon fibers of the second carbon layer contact each other in the protective film to establish the conductive path.

15. The electrochemical device as recited in claim 11, wherein the metallic plate is a separator plate and/or a bipolar plate.

16. A method of forming an electrochemical device comprising:
disposing a protective film between a metallic separator plate and a carbon layer, the carbon layer having a porous construct established by a plurality of carbon fibers; and
establishing a protective barrier in response to compressing the carbon layer to cause the protective film to impregnate the porous construct such that the carbon layer is substantially impermeable to hydrogen fluid.

17. The method as recited in claim 16, wherein the protective film comprises a non-conductive material, and the compressing step occurs such that at least some of the carbon fibers extend through the protective film to establish a conductive path between the carbon layer and the metallic plate.

18. The method as recited in claim 16, wherein the compressing step includes applying a compressive force between approximately 420 pounds per square inch (PSI) and approximately 500 PSI.

19. The method as recited in claim 16, wherein the disposing step includes spraying a plastic material on the separator plate and/or the carbon layer to establish the protective film.

20. The method as recited in claim 16, further comprising:
arranging the protective barrier adjacent to a fluid stream of a cathode.
